(19) United States
(12) Patent Application Publication
(10) Pub. No.: US 2014/0040684 A1
(43) Pub. Date: Feb. 6, 2014

(54) SYSTEM FOR PACKET COMMUNICATION AND COMMUNICATION METHOD

(71) Applicant: FUJITSU LIMITED, Kawasaki-shi (JP)

(72) Inventors: Toshihiro Tomozaki, Sagamihara (JP); Yoshiki Okumura, Kosai (JP); Yutaka Sekino, Toyohashi (JP); Naoki Maezawa, Toyohashi (JP); Chikahiro Deguchi, Toyohashi (JP); Hiroaki Watanabe, Hamamatsu (JP); Hideyuki Negi, Hamamatsu (JP)

(73) Assignee: FUJITSU LIMITED, Kawasaki (JP)

(21) Appl. No.: 13/939,582

(22) Filed: Jul. 11, 2013

(30) Foreign Application Priority Data
Aug. 2, 2012 (JP) 2012-172339

(51) Int. Cl. H04L 12/26

(52) U.S. Cl. CPC H04L 43/50
USPC 714/712

(57) ABSTRACT

A system includes a transmitting device configured to transmit a packet, and a receiving device connected through a switch device to the transmitting device, the receiving device being configured to receive the packet, wherein the switch device includes a first memory storing first expected value information indicative of an expected value of a fixed value region, the fixed value region being a region whose value is determined in advance in a transaction layer packet, and a switch control unit configured to compare a value of the fixed value region of the transaction layer packet received from the transmitting device with the expected value and make an error response to the transmitting device if the value of the fixed value region is different from the expected value.

### CROSS-REFERENCE TO RELATED APPLICATION

This application is based upon and claims the benefit of priority from the prior Japanese Patent Application No. 2012-172339, filed on Aug. 2, 2012, the entire contents of which are incorporated herein by reference.

### FIELD

The embodiment discussed herein is related to a system for packet communication and a communication method.

### BACKGROUND

Some devices adopt Peripheral Component Interconnect (PCI)-Express, which is a kind of high-speed serial interface, as interfaces (I/Fs) used during communication between modules.

FIG. 1 is a configuration diagram of a system for inter-module communication that adopts a related art PCI-Express I/F.

A system 1001 includes a module 1011-i (i=1 to 12) and a switch 1031-j (j=1 to 5).

The switch 1031-1 is connected to the modules 1011-1, 1011-2, and 1011-3 and the switch 1031-3.

The switch 1031-2 is connected to the modules 1011-4, 1011-5, and 1011-6 and the switch 1031-3.

The switch 1031-3 is connected to the switches 1031-1, 1031-2, 1031-4, and 1031-5.

The switch 1031-4 is connected to the modules 1011-7, 1011-8, and 1011-9 and the switch 1031-3.

The switch 1031-5 is connected to the modules 1011-10, 1011-11, and 1011-12 and the switch 1031-3.

The connection between the module 1011 and the switch 1031 and the connection between the switches 1031 are made via a serial bus using PCI-Express.

Note that, in the below description of related art technologies, the module 1011-i is sometimes referred to as a “module i” and the switch 1031-j is sometimes referred to as a “switch j”.

In the system 1001 of FIG. 1, the modules 1011 are not directly connected to one another and are connected through the switches 1031. At the time of performing communication between the modules 1011, a packet is transferred through the switches 1031, and additionally a module to which the packet is destined (hereinafter referred to as a “transmission destination module) tries to detect an error and returns an error response to a module from which the packet has been transmitted (hereinafter referred to as a “transmission source module”) if an error is found.

PCI-Express has a layer structure as its standard and thus transmission and reception are performed in such a manner that the roles are clearly divided for every layer, and an error check is made for every layer of the module 1011 that performs reception.

In the switches 1031 through which packet communication occurs, error handling of the data link layer in a point-to-point manner is performed; however, error handling of the transaction layer, which is an upper layer of PCI-Express, is not performed. Therefore, as for error handling of the transaction layer, error handling is performed in the transmission destination module at the final stage only in an end-to-end manner.

FIG. 2 illustrates a data structure of a transaction layer packet.

A transaction layer packet includes a header portion and a payload portion, and, in addition, is provided with end-to-end cyclic redundancy check (ECRC) for securing data in the entire area of the packet.

At the time the destination module detects an error in the transaction layer, if the received packet is of the non-posted packet kind, a reception module returns an error response as a completion packet to the transmission source module.

FIG. 3 is a sequence diagram of a related art packet transmission process.

With reference to FIG. 3, a description is given of the case where a transmission source module 1 transmits a packet by way of the switches 1, 3, and 4 to a transmission destination module 7, an ECRC error is detected in the transmission destination module 7, an error response is returned, and, upon receiving the error response, the transmission source module 1 retransmits the packet with the error.

In order for the module 1 to transmit a packet (transmission packet) to the module 7, the module 1 transmits the packet to the switch 1 (step S1101) first.

The switch 1 receives the transmission packet (step S1102), and transfers the transmission packet to the switch 3. The switch 3 receives the transmission packet, and transfers the transmission packet to the switch 4. The switch 4 receives the transmission packet, and transmits the transmission packet to the module 7 (step S1103).

The module 7 receives the transmission packet (step S1104), and performs an ECRC check on the transaction layer packet (step S1105). Then, an ECRC error is detected (step S1106) and the module 7 returns an error response packet to the module 1 (step S1107).

The switch 4 receives the error response packet (step S1108). The error response packet is transferred from the switch 4 through the switch 3 to the switch 1.

The switch 1 transmits the error response packet to the module 1 (step S1109).

The module 1 receives the error response packet (step S1110), and retransmits the packet (a retry packet) to the module 7 (step S1111).

The switch 1 receives the retry packet (step S1112). The retry packet is transferred from the switch 1 through the switch 3 to the switch 4.

The switch 4 transmits the retry packet to the module 7 (step S1113).

The module 7 receives the retry packet (step S1114).

In the related art technologies, if data of a packet on the transaction layer (a transaction layer packet) is broken during communication in the inside of a switch through which the communication occurs, ECRC error handling is not performed in the switch, and an ECRC error check is not made as far as the transaction layer of the transmission destination module.

For this reason, the broken packet is transferred from the switch in which the data is corrupted to the transmission destination module at the final stage in the same way as a usual packet. This imposes a load on a PCI-Express bandwidth between the switch in which the data is corrupted and the transmission destination module at the final stage, and thus raises a problem in that the transfer rate decreases in the bandwidth by an amount corresponding to the number of broken packets.

Regarding a transaction layer packet received by the transmission destination module at the final stage, an ECRC error check of all the areas of the transaction layer packet is made in the transaction layer of the transmission destination module. Therefore, when data in an unused area, which is common to all the modules in accordance with device specifications, in the transaction layer packet is broken, the packet will be processed as an error packet. For this reason, retransmission of a packet is performed as error recovery, resulting in imposing a load on the bandwidth of PCI-Express in the retransmission path. Thus, there is a problem in that the transfer rate decreases by an amount corresponding to the number of retry packets that are redundant in terms of device specifications.

An issue of the present disclosure is to inhibit a decrease in the transfer rate in packet communication.

Japanese Laid-open Patent Publication Nos. 2006-195870, 2005-129173, and 2009-290686 disclose related art technologies.

### SUMMARY

According to an aspect of the embodiments, an apparatus includes a system includes a transmitting device configured to transmit a packet, and a receiving device connected through a switch device to the transmitting device, the receiving device being configured to receive the packet, wherein the switch device includes a first memory storing first expected value information indicative of an expected value of a fixed value region, the fixed value region being a region whose value is determined in advance in a transaction layer packet, and a switch control unit configured to compare a value of the fixed value region of the transaction layer packet received from the transmitting device with the expected value and make an error response to the transmitting device if the value of the fixed value region is different from the expected value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a system for inter-module communication that adopts a related art PCI-Express I/F;

FIG. 2 illustrates a data structure of a transaction layer packet;

FIG. 3 is a sequence diagram of a related art packet transmission process;

FIG. 4 is a configuration diagram of a system according to an embodiment;

FIG. 5 illustrates an example of a transaction layer packet according to the embodiment;

FIG. 6 illustrates filter packet information according to the embodiment;

FIG. 7 is a detailed configuration diagram of a module according to the embodiment.

FIG. 8 is a detailed configuration diagram of a switch according to the embodiment;

FIGS. 9A and 9B are detailed configuration diagrams of the system according to the embodiment;

FIG. 10 is a flowchart of a packet communication process according to the embodiment;

FIG. 11 illustrates a packet communication process according to the embodiment;

FIG. 12A illustrates a process of the transaction layer of the switch according to the embodiment (when an error is not detected);

FIG. 12B illustrates a process of the transaction layer of the switch according to the embodiment (when an error is detected);

FIG. 13 illustrates packet communication according to a related art technology;

FIG. 14 illustrates packet communication according to the embodiment;

FIG. 15 illustrates states of a transaction layer packet according to the related art technology and operations of a switch;

FIG. 16 illustrates states of a transaction layer packet according to the embodiment and operations of a switch;

FIG. 17 illustrates an error check process of the modules according to the embodiment;

FIG. 18 illustrates an error check process of the modules according to the related art technology;

FIG. 19 illustrates states of a transaction layer packet according to the related art technology and the results of operations of the module; and

FIG. 20 illustrates states of a transaction layer packet according to the embodiment and the results of operations of the module.

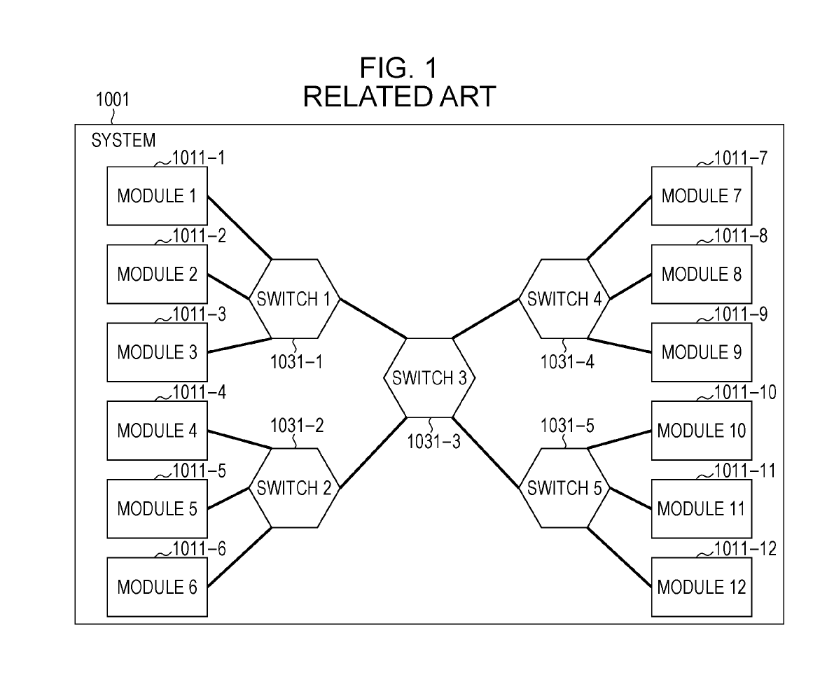

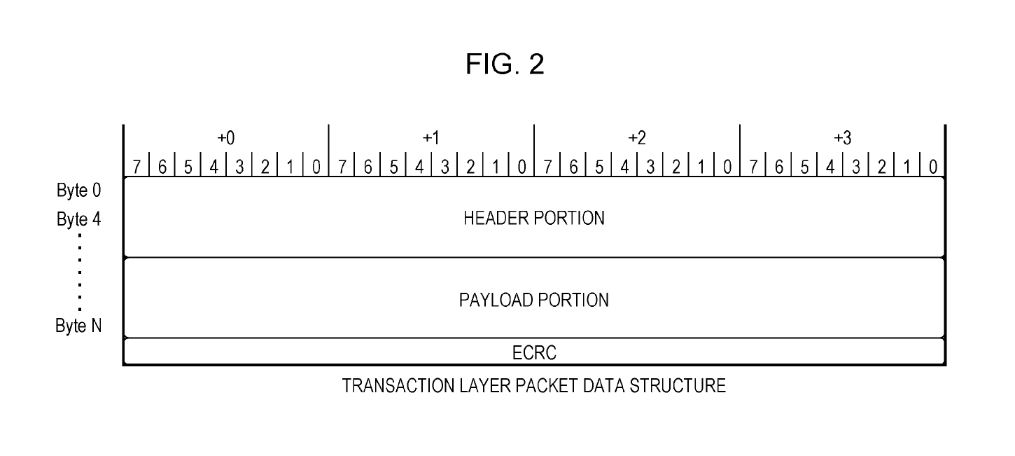

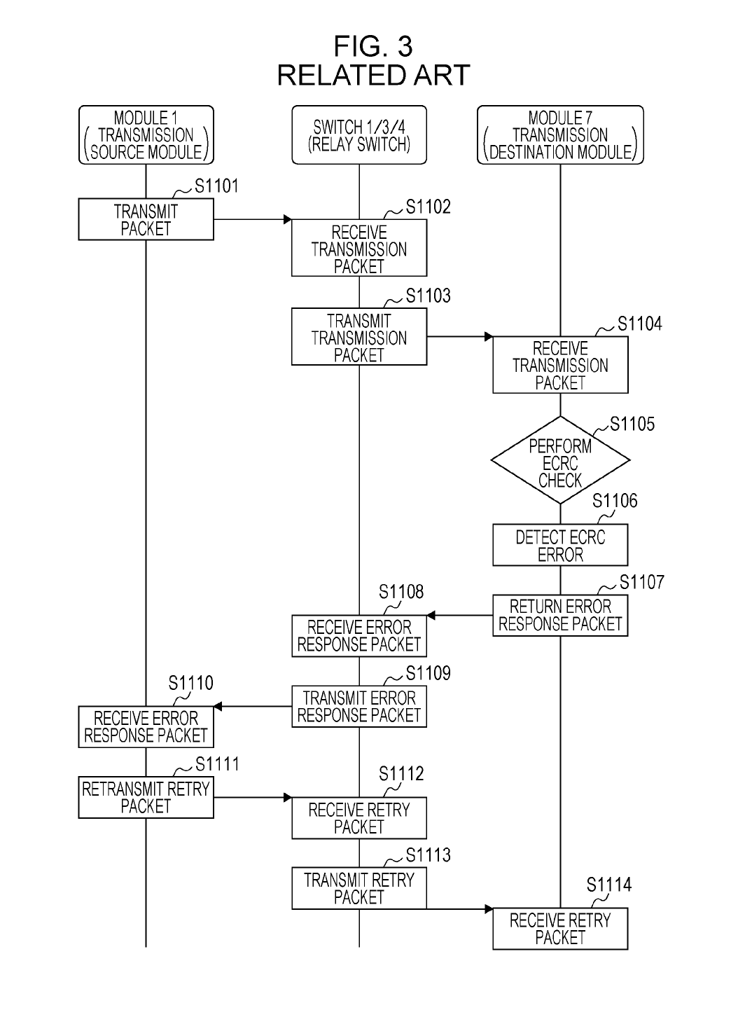

### DESCRIPTION OF EMBODIMENT

Hereinafter, an embodiment will be described with reference to the drawings.

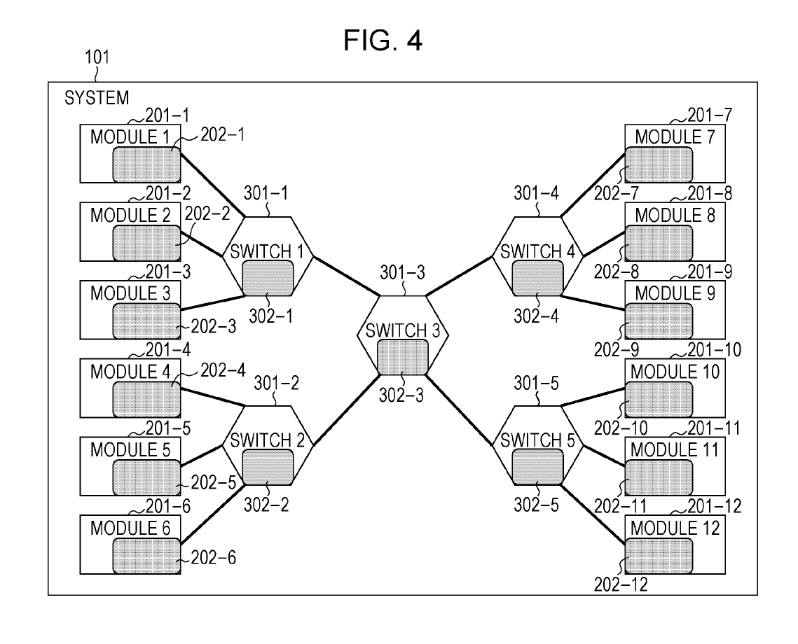

FIG. 4 is a configuration diagram of a system according to an embodiment.

A system 101 includes modules 201-i (i=1 to 12) and switches 301-j (j=1 to 5).

The module 201-i is a device, such as a system board or an input/output (I/O) board, for example. The module 201-i has filter packet information 202-i. The module 201-i performs processing, such as overwriting of fixed value regions of a transaction layer packet, using the filter packet information 202-i.

The switch 301-j is a device that performs an error check and routing of a packet. The switch 301-j has filter packet information 302-i.

The switch 301-j performs an error check on a transaction layer packet on the basis of filter packet information 302-i.

The switch 301-1 is connected to the modules 201-1, 201-2, and 201-3 and the switch 301-3.

The switch 301-2 is connected to the modules 201-4, 201-5, and 201-6 and the switch 301-3.

The switch 301-3 is connected to the switches 301-1, 301-2, 301-4, and 301-5.

The switch 301-4 is connected to the modules 201-7, 201-8, and 201-9 and the switch 301-3.

The switch 301-5 is connected to the modules 201-10, 201-11, and 201-12, and the switch 301-3.

The connection between the module 201 and the switch 301 and the connection between the switches 301 are made via a serial bus using PCI-Express. Packet communication between the module 201 and the switch 301 and between switches 301 is performed in accordance with the PCI-Express standards.

Note that, in the below description of the embodiment, the module 201-i is sometimes referred to as the “module i” and the switch 301-j is sometimes referred to as the “switch j”.

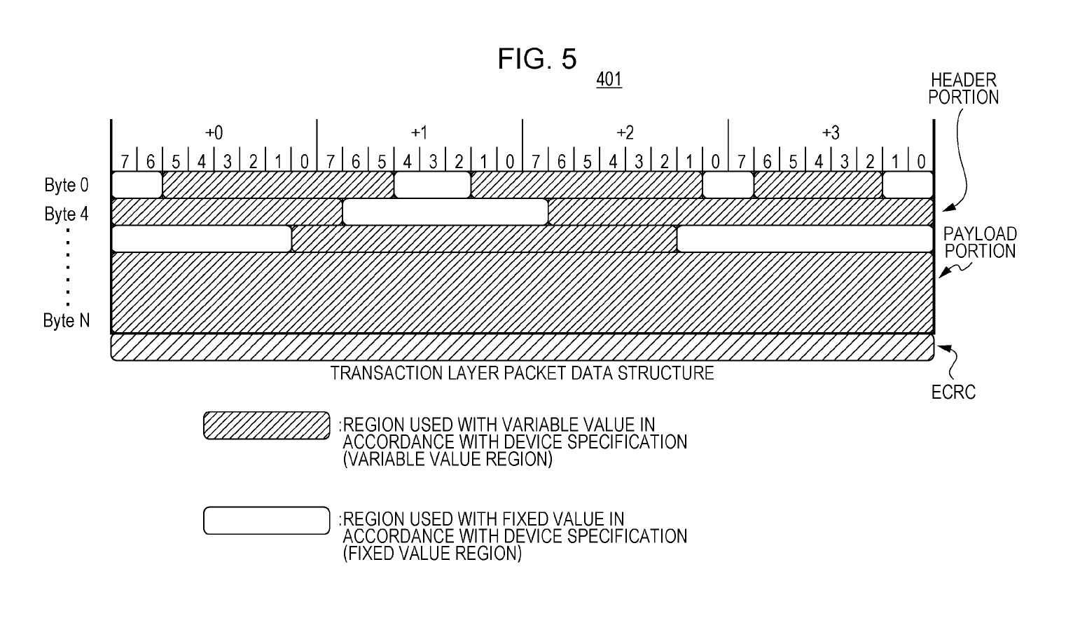

FIG. 5 illustrates an example of a transaction layer packet according to the embodiment.

The transaction layer packet includes a header portion and a payload portion, and, in addition, is provided with end-to-end cyclic redundancy check (ECRC) for securing data in the entire area of the packet.

Information such as the length size, address, and packet type, for example, is written in the header portion.

The payload portion is the main body of data other than the additional information and the like written in the header portion.

In the transaction layer packet, there is a region that is used with a variable value in accordance with a device specification (variable value region) and a region that is used with a fixed value in accordance with a device specification (fixed value region). Note that the ECRC, which is a variable value, will be described assuming that the ECRC is included neither in the variable value region nor in the fixed value region.

In FIG. 5, the variable value regions are hatched and the fixed value regions are illustrated in white.

In the embodiment, values (fixed values) determined in advance as device specifications are written in given regions of the header portion of a transaction layer packet. That is, the fixed value regions are included in the header portion of the transaction layer packet. Where the fixed value regions of a transaction layer packet is located and what values are written in the fixed value regions is determined in advance as device specifications.

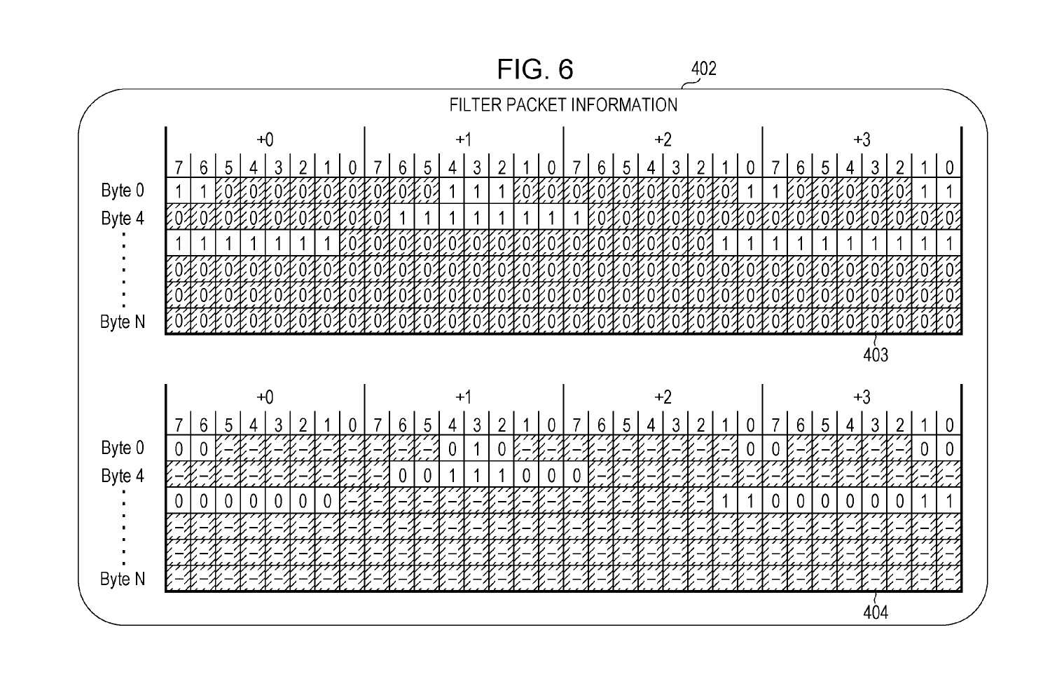

FIG. 6 illustrates filter packet information according to the embodiment.

Filter packet information 402 of FIG. 6 is filter packet information corresponding to a transaction layer packet 401 of FIG. 5.

The filter packet information 402 corresponds to the filter packet information 202 and 302 of FIG. 4.

The filter packet information 402 includes a variable value region/fixed value region information table 403 and a fixed value region expected value information table 404.

The variable value region/fixed value region information table 403 is information indicating the locations of fixed value regions and variable value regions of the transaction layer packet 401.

In the variable value region/fixed value region information table 403, the fixed value region is represented as “1” and the variable value region is represented as “0”.

Note that since the fixed value region is not included in the payload portion and is included only in the header portion, the variable value region/fixed value region information table 403 may indicate only the locations of fixed value regions and variable value regions of the header portion and omit the locations of variable value regions of the payload portion.

The fixed value region expected value information table 404 is information indicating the values (expected values) to be written in the fixed value region in accordance with device specifications in the transaction layer packet 401.

In the fixed value region expected value information table 404, the expected values (“0” or “1”) of a fixed value region of the transaction layer packet 401 are written in a region corresponding to that fixed value region. Also in the fixed value region expected value information table 404, a mark “-” indicating an arbitrary value is written in a hatched region corresponding to the variable value region of the transaction layer packet 401.

Note that since the fixed value region is not included in the payload portion and is included only in the header portion, the fixed value region expected value information table 404 may include only information indicating the expected values of fixed value regions and arbitrary values of variable value regions of the header portion and omit information indicating arbitrary values of variable value regions of the payload portion.

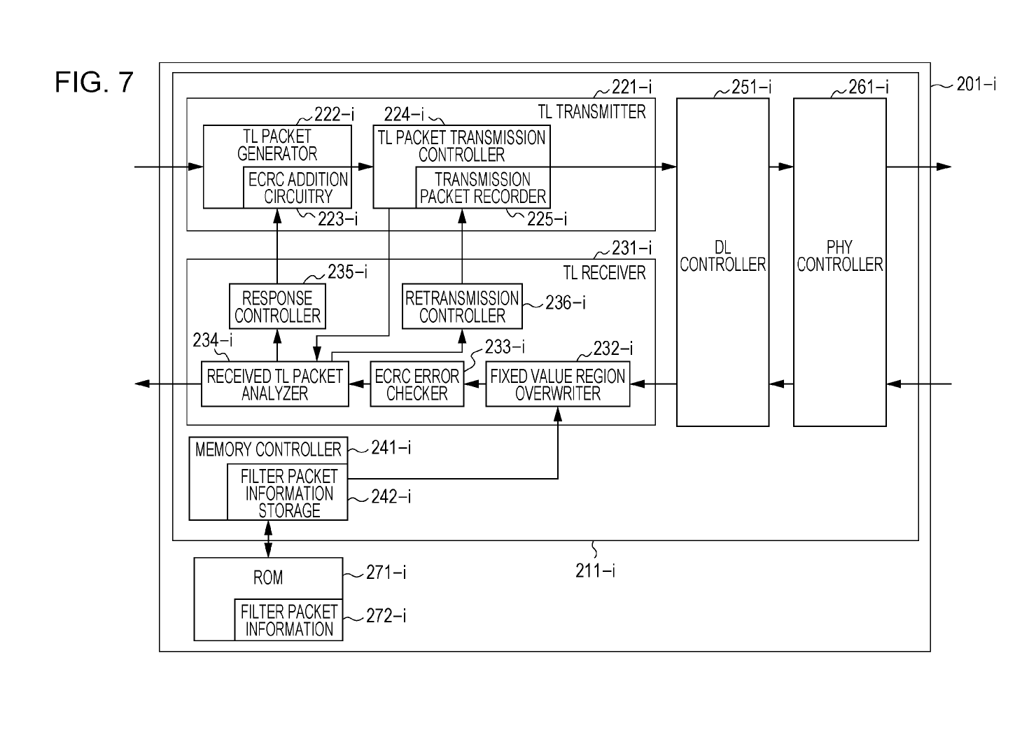

FIG. 7 is a detailed configuration diagram of a module according to the embodiment.

The module 201-i includes a packet processor 211-i and a read only memory (ROM) 271-i.

The packet processor 211-i includes a TL transmitter 221-i, a TL receiver 231-i, a memory controller 241-i, a DL controller 251-i, and a PHY controller 261-i.

The packet processor 211-i performs operations such as packet generation and an error check. The packet processor 211-i is implemented by hardware circuitry, a processor, and other components, for example.

The TL transmitter 221-i and the TL receiver 231-i perform control of transmission and reception in the transaction layer.

The TL transmitter 221-i includes a TL packet generator 222-i and a TL packet transmission controller 224-i.

The TL packet generator 222-i includes ECRC addition circuitry 223-i.

The TL packet generator 222-i generates a transaction layer packet on the basis of a request for generation of a new packet given from the software layer, which is a higher-level layer, or an instruction from a response controller 235-i.

The ECRC addition circuitry 223-i generates an ECRC code for the transaction layer packet, and adds the ECRC code to the transaction layer packet. The transaction layer packet to which the ECRC code is added is transmitted to the TL packet transmission controller 224-i.

The TL packet transmission controller 224-i includes a transmission packet recorder 225-i.

The TL packet transmission controller 224-i transmits the transaction layer packet to a DL controller 251-i. When receiving a retransmission instruction from a retransmission controller 236-i, the TL packet transmission controller 224-i retransmits a transaction layer packet from information in the transmission packet recorder 225-i.

The transmission packet recorder 225-i records the transaction layer packet received from the TL packet generator 222-i.

The TL receiver 231-i includes a fixed value region overwriter 232-i, an ECRC error checker 233-i, a received TL packet analyzer 234-i, the response controller 235-i, and the retransmission controller 236-i.

The fixed value region overwriter 232-i receives filter packet information 272-i from the memory controller 241-i, and overwrites the fixed value region of the transaction layer packet on the basis of the filter packet information 272-i. In particular, the fixed value region overwriter 232-i determines the locations of fixed value regions of the transaction layer packet received from the DL controller 251-i on the basis of the variable value region/fixed value region information table 403. Then, the fixed value region overwriter 232-i overwrites the fixed value regions of the transaction layer packet received from the DL controller 251-i with expected values of the fixed value region expected value information table 404.

The ECRC error checker 233-i checks the transaction layer packet received from the fixed value region overwriter 232-i for an ECRC error. The ECRC error checker 233-i transmits the transaction layer packet and the result of the error check to the received TL packet analyzer 234-i.

The received TL packet analyzer 234-i analyzes the transaction layer packet received from the ECRC error checker 233-i, and performs processing based on the analysis result. In particular, if the transaction layer packet is a non-posted packet, the received TL packet analyzer 234-i instructs the response controller 235-i to make a response, on the basis of the result from the ECRC error checker 233-i and the analysis result of the transaction layer packet. If the transaction layer packet is a response completion packet, the received TL packet analyzer 234-i instructs the retransmission controller 236-i to perform retransmission if the result from the ECRC error checker 233-i is error detection, whereas the received TL packet analyzer 234-i transmits the content of a response to the software layer, which is a higher-level layer, if the result from the ECRC error checker 233-i is that an error is not detected.

On the basis of the instruction from the received TL packet analyzer 234-i, the response controller 235-i instructs the TL packet generator 222-i to generate a response completion packet.

On the basis of the instruction from the received TL packet analyzer 234-i, the retransmission controller 236-i instructs the TL packet transmission controller 224-i to retransmit a packet.

The memory controller 241-i reads the filter packet information 272-i from the ROM 271-i and stores the read filter packet information 272-i in a filter packet information storage 242-i. The memory controller 241-i also outputs the filter packet information 272-i to the fixed value region overwriter 232-i.

The filter packet information storage 242-j stores the filter packet information 272-i read from the ROM 271-i.

The DL controller 251-i controls transmission and reception in the data link layer.

The PHY controller 261-i controls transmission and reception in the physical layer.

The ROM 271-i stores the filter packet information 272-i. The filter packet information 272-i corresponds to the filter packet information 202-i of FIG. 4 and the filter packet information 402 of FIG. 6.

The ROM 271-i is an example of a memory, and a random access memory (RAM) or the like may be used as the ROM 271-i.

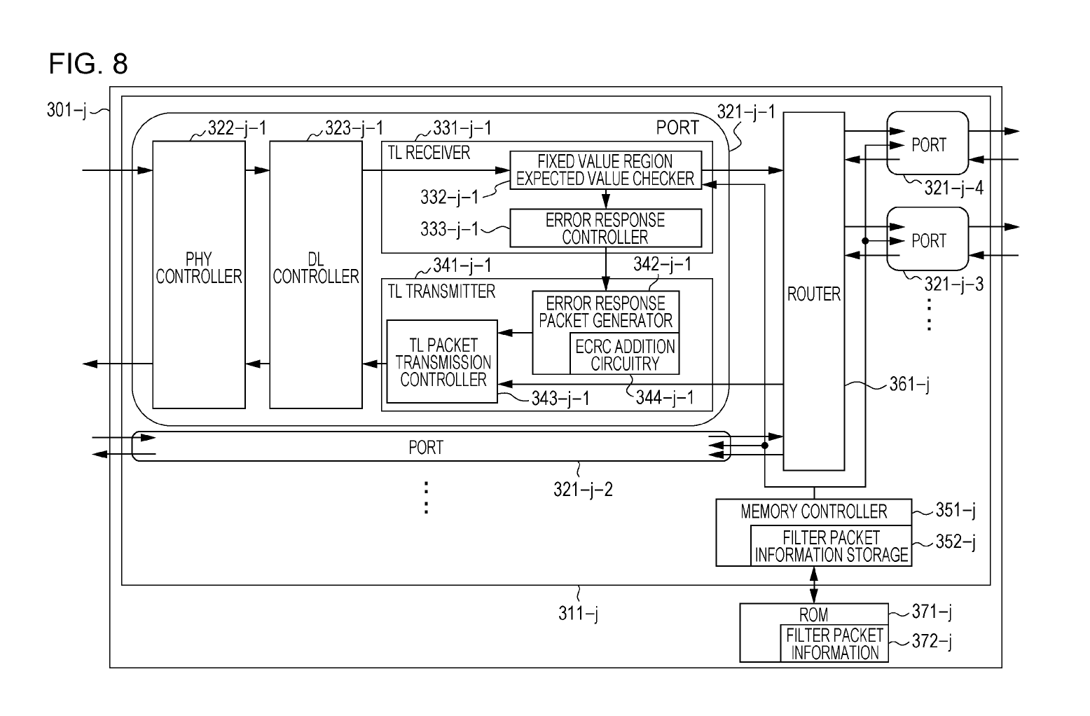

FIG. 8 is a detailed configuration diagram of a switch according to the embodiment.

The switch 301-j includes switch circuitry 311-j and a ROM 371.

The switch circuitry 311-j includes ports 321-j-k (k=1 to 4), a memory controller 351-j, and a router 361-j.

The port 321-j-k is an interface for inputting and outputting from and to a device connected to the switch 301-j.

The ports 321-j-2 to 321-j-4 each have the same configuration and function as the port 321-j-1, and therefore only the details of the port 321-j-1 are illustrated in FIG. 8.

The port 321-j-1 includes a PHY controller 322-j-1, a DL controller 323-j-1, a TL receiver 331-j-1, and a TL transmitter 341-j-1.

The PHY controller 322-j-1 controls transmission and reception in the physical layer.

The DL controller 323-j-1 controls transmission and reception in the data link layer.

The TL receiver 331-j-1 and the TL transmitter 341-j-1 control transmission and reception in the transaction layer.

The TL receiver 331-j-1 includes a fixed value region expected value checker 332-j-1 and an error response controller 333-j-1.

The fixed value region expected value checker 332-j-1 receives filter packet information 372-j from the memory controller 351-j and checks the values of fixed value regions of the transaction layer packet on the basis of the filter packet information 372-j. In particular, the fixed value region expected value checker 332-j-1 determines the locations of fixed value regions of the transaction layer packet received from the DL controller 323-j-1 on the basis of the variable value region/fixed value region information table 403. Then, the fixed value region expected value checker 332-j-1 compares the values of fixed value regions of the transaction layer packet received from the DL controller 323-j-1 with the expected values of the fixed value region expected value information table 404 to check whether the values of fixed regions match the expected values (expected value check).

When the values of the fixed value regions match the expected values (when an error is not detected), the fixed value region expected value checker 332-j-1 transfers the transaction layer packet to the router 361-j.

When the values of fixed value regions do not match the expected values (when an error is detected), the fixed value region expected value checker 332-j-1 instructs the error response controller 333-j-1 to provide an error response.

In response to the instruction from the fixed value region expected value checker 332-j-1, the error response controller 333-j-1 instructs an error response packet generator 342-j-1 to generate an error response packet.

The TL transmitter 341-j-1 includes the error response packet generator 342-j-1 and a TL packet transmission controller 343-j-1.

The error response packet generator 342-j-1 includes ECRC addition circuitry 344-j-1.

The error response packet generator 342-j-1 generates a transaction layer packet of an error response on the basis of an instruction from the error response controller 333-j-1.

The ECRC addition circuitry 344-j-1 generates an ECRC code for the transaction layer packet of an error response, and adds the ECRC code to the transaction layer packet. The transaction layer packet to which the ECRC code is added is transmitted to the TL packet transmission controller 343-j-1.

The TL packet transmission controller 343-j-1 transmits the received transaction layer packet to the DL controller 323-j-1.

The memory controller 351-j includes a filter packet information storage 352-j.

The memory controller 351-j reads the filter packet information 372-j from a ROM 371-j, and stores the read filter packet information 372-j in the filter packet information storage 352-j. The memory controller 351-j outputs the filter packet information 372-j to the fixed value region expected value checker 332 of each port 321-j-k.

The filter packet information storage 352-j stores the filter packet information 372-j read from the ROM 371-j.

The router 361-j analyzes the transaction layer packet received from the TL receiver 331 of each port 321-j-k and routes the packet to the TL transmitter 341 of the port 321-j-k, which corresponds to the transmission destination of the packet.

The ROM 371-j stores the filter packet information 372-j. The filter packet information 372-j corresponds to the filter packet information 302-j of FIG. 4 and to the filter packet information 402 of FIG. 6. The ROM 371-j is an example of a memory, and a RAM or the like may be used as the ROM 371-j.

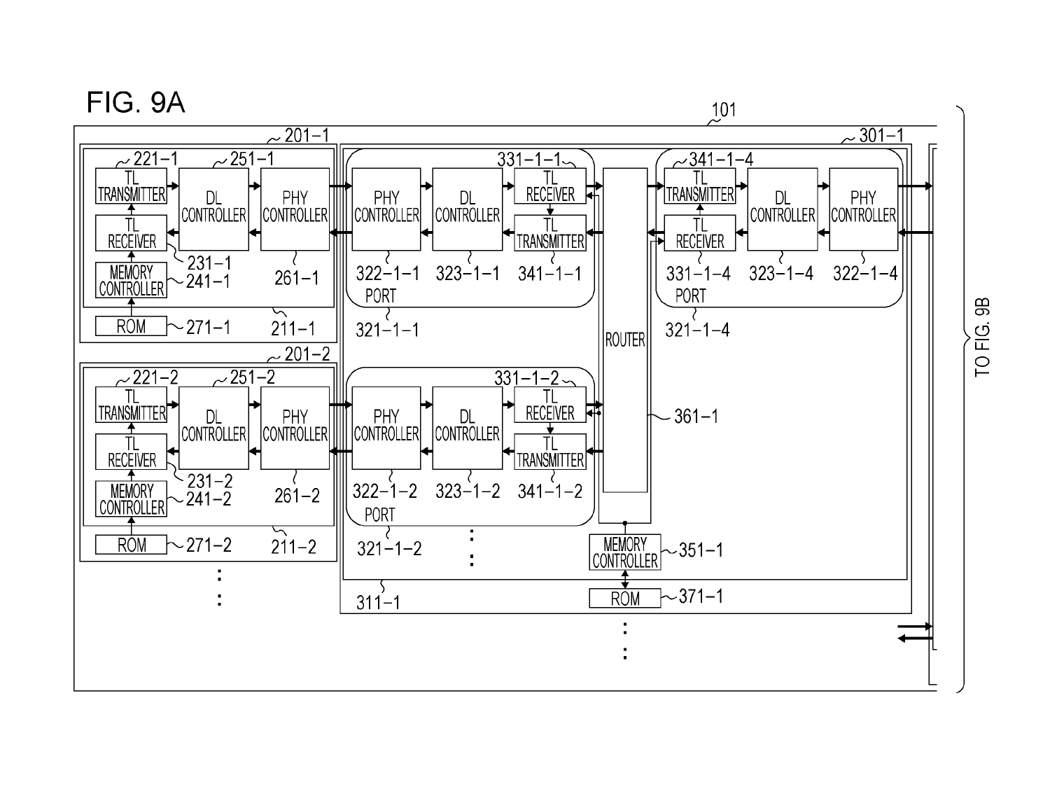

FIGS. 9A and 9B are detailed configuration diagrams of the system according to the embodiment.

In the system 101 of FIGS. 9A and 9B, only the modules 201-1, 201-2, 201-7, and 201-8, and the switches 301-1, 301-3, and 301-4 are illustrated, and the illustrations of the modules 201-3 to 201-6 and 201-9 to 201-12, and the switches 301-2 and 301-5 are omitted. Also, the illustration of the detailed configuration of the switch 301-3 is omitted.

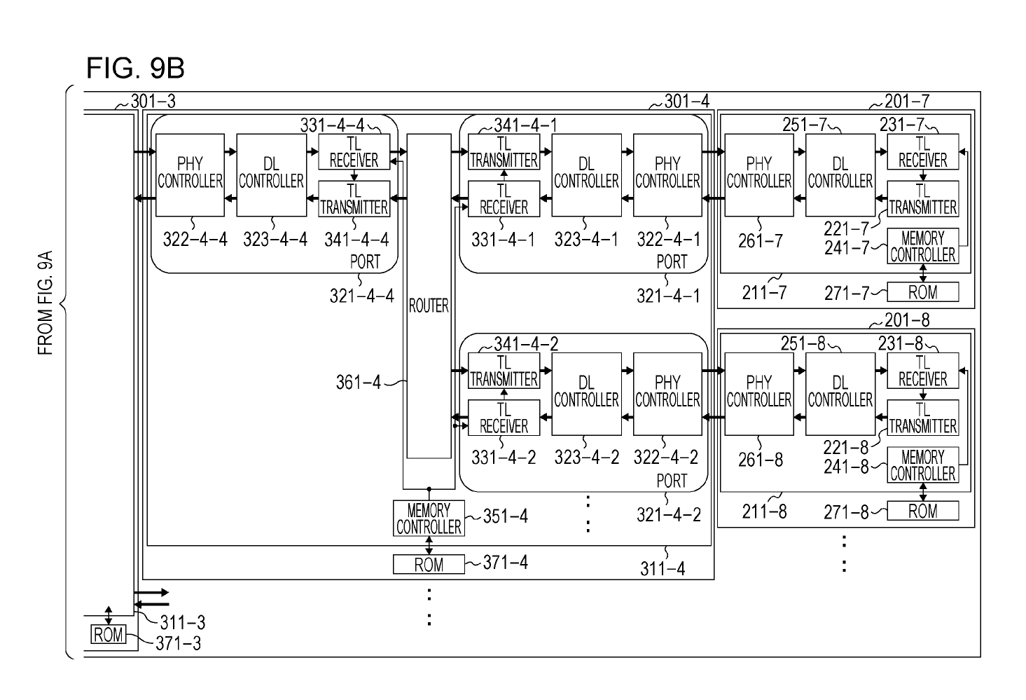

FIG. 10 is a flowchart of a packet communication process according to the embodiment.

Here, a description is given of a process of the case where a packet is transmitted from the module 201-1 (transmission source module) through the switches 301-m (m=1, 3, 4) to the module 201-7 (transmission destination module).

In step S501, the memory controller 241-1 of the module 201-1 reads the filter packet information 272-1 from the ROM 271-1 and transmits the filter packet information 272-1 to the fixed value region overwriter 232. This allows the fixed value region overwriter 232 to recognize the filter packet information 272-1 and to make use of the filter packet information 272-1.

In step S502, the memory controller 351-m of the switch 301-m reads filter packet information 372-m from a ROM 371-m and transmits the filter packet information 372-m to a fixed value region expected value checker 332-m-k. This allows the fixed value region expected value checker 332-m-k to recognize the filter packet information 372-m and to make use of the filter packet information 372-m.

In step S503, the memory controller 241-7 of the module 201-7 reads the filter packet information 272-7 from the ROM 271-7 and transmits the filter packet information 272-7 to the fixed value region overwriter 232-7. This allows the fixed value region overwriter 232-7 to recognize the filter packet information 272-7 and to make use of the filter packet information 272-7.

The above-mentioned reading of the filter packet information 272-1, 272-7, and 372-m is carried out, for example, when the power supplies of the modules 201-1 and 201-7 and the switch 301-m are turned on, respectively.

In step S504, the module 201-1 transmits a packet (transmission packet) to the module 201-7.

In step S505, the switch 301-1 receives the transmission packet. Then, the TL receiver 331-1-1 receives the transaction layer packet via the PHY controller 322-1-1 and the DL controller 323-1-1.

In step S506, the fixed value region expected value checker 332-1-1 compares the values of fixed value regions of the transaction layer packet with the expected values of the fixed value region expected value information table 404 of the filter packet information 372-1 to check whether the values of the fixed value match the expected values (expected value check). Note that the fixed value region expected value checker 332-1-1 determines the locations of fixed value regions of the transaction layer packet 401 with reference to the variable value region/fixed value region information table 403 of the filter packet information 372-1. If the values of fixed value regions match the expected values, that is, if an error is not detected (no error), the control proceeds to step S510, whereas if the values of fixed value regions do not match the expected values, that is, if an error is detected (error), the control proceeds to step S507.

In step S507, the fixed value region expected value checker 332-1-1 instructs the error response controller 333-1-1 to make an error response. The error response controller 333-1-1 instructs the error response packet generator 342-1-1 to generate an error response packet. The generated error response packet is transmitted from the switch 301-1 to the module 201-1.

In step S508, the module 201-1 receives the error response packet.

In step S509, the module 201-1 retransmits a packet (retry packet). Thereafter, assuming that the retry packet is a transmission packet, the same operations as the operations in and after step S505 are performed.

In step S510, the fixed value region expected value checker 332-1-1 transfers the transaction layer packet to the router 361-1. The transaction layer packet is transferred from the router 361-1 to the port 321-1-4, and processes of the transaction layer, the data link layer, and the like are performed in the port 321-1-4. Then, the transmission packet is transmitted from the port 321-1-4 to the switch 301-3.

Thereafter, in the switch 301-3, as in the switch 301-1, operations such as an expected value check of the fixed value region are performed, and the transmission packet is transferred to the switch 301-4. Additionally, in the switch 301-4, as in the switch 301-1, operations such as an expected value check of fixed value regions are performed, and the transmission packet is transferred to the module 201-7.

In step S511, the module 201-7 receives the transmission packet. Then, the TL receiver 231-7 receives the transaction layer packet 401 through the PHY controller 261-7 and the DL controller 251-7.

In step S512, the fixed value region overwriter 232-7 overwrites the values of fixed value regions of the transaction packet 401 with the expected values of the fixed value region expected value information table 404 of the filter packet information 272-7. Note that the fixed value region overwriter 232-7 determines the locations of fixed value regions of the transaction layer packet 401 using the variable value region/fixed value region information table 403 of the filter packet information 272-7.

In step S513, the ECRC error checker 233-7 checks the transaction packet whose fixed value region has been overwritten for an error. If an error is detected, the control proceeds to step S514, whereas if an error is not detected, the control proceeds to step S515.

In step S514, the module 201-7 transmits an error response packet destined to the module 201-1.

In step S515, the module 201-7 transmits a normal response packet destined to the module 201-1.

In step S516, the switch 301-4 receives the response packet (the normal response packet or the error response packet). Then, the TL receiver 331-4-1 receives the transaction layer packet through the PHY controller 322-4-1 and the DL controller 323-4-1.

In step S517, the TL receiver 331-4-1 performs an expected value check of the transaction layer packet of the response packet. The operations of an expected value check are the same as those in step S506, and therefore a description of the operations is omitted. If the values of fixed value regions match the expected values, that is, if an error is not detected (no error), the control proceeds to step S519, whereas if the values of fixed value regions do not match the expected values, that is, if an error is detected (error), the control proceeds to step S518.

In step S518, the TL transmitter 341-4-1 generates an error response packet. The generated error response packet is transmitted from the switch 301-4 to the module 201-7.

In step S519, the fixed value region expected value checker 332-4-1 transfers the transaction layer packet to the router 361-4. The transaction layer packet is transferred from the router 361-1 to the port 321-4-4, and processes of the transaction layer, the data link layer, and the like are performed in the port 321-4-4. Then, a response packet is transmitted from the port 321-4-4 to the switch 301-3.

Thereafter, in the switch 301-3, as in the switch 301-4, operations such as an expected value check of the fixed value regions are performed, and the response packet is transferred to the switch 301-1. Additionally, in the switch 301-1, as in the switch 301-4, operations such as an expected value check of the fixed value regions are performed, and the response packet is transferred to the module 201-1.

In step S520, the module 201-1 receives the response packet.

In step S521, the module 201-1 retransmits a packet (retry packet) when the response packet received in step S520 is an error response packet. Thereafter, assuming that the retry packet is a transmission packet, the same operations as those in and after step S505 are performed.

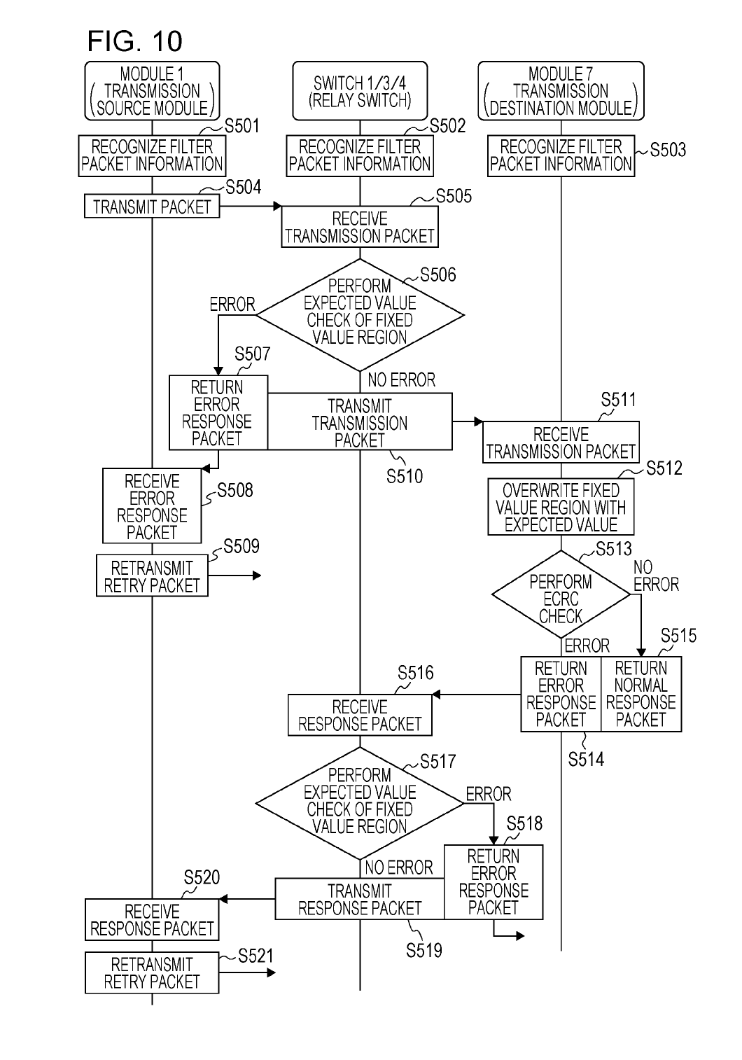

FIG. 11 illustrates a packet communication process according to the embodiment.

In FIG. 11, an illustration is given of a process in the case where a packet is transmitted from the module 201-1 (transmission source module) through the switches 301-m (m=1, 3, 4) to the module 201-7 (transmission destination module).

In the module 201-1, the transaction layer receives a request from the software layer, and generates a transaction layer packet (TLP). The transaction layer packet is forwarded to the data link layer, and a data link layer packet (DLLP) is generated by the data link layer.

The data link layer packet is forwarded to the physical layer, and an ordered set is generated by the physical layer.

A transmission packet containing the TLP, DLLP, and ordered set is forwarded to the mechanical layer, and is transmitted to the switch 301-1.

The mechanical layer of the switch 301-1 receives the transmission packet, and transmits the transmission packet to the physical layer. The physical layer transmits the data link layer packet and the transaction layer packet to the data link layer. The data link layer transmits the transaction layer packet to the transaction layer.

The transaction layer of the switch 301-1 performs an expected value check on the transaction layer packet on the basis of filter packet information. When no error is found, the transaction layer packet is transmitted to the router 361-1.

Thereafter, a DLLP is generated by the data link layer and an ordered set is generated by the physical layer, and a transmission packet is transmitted to the switch 301-3 and is further transmitted from the switch 301-3 through the switch 301-4 to the module 201-7.

Note that, in the transaction layer of each of the switches 301-3 and 301-4, an expected value check of the transaction layer packet based on the filter packet information is performed in the same way as in the switch 301-1.

In the transaction layer of the module 201-7, overwriting of fixed value regions with the expected values using filter packet information, and an ECRC error check are carried out.

Processes of the transaction layer in the case where data in fixed value regions of a transaction layer packet is not broken (normal case) and in the case where data is broken will be described next.

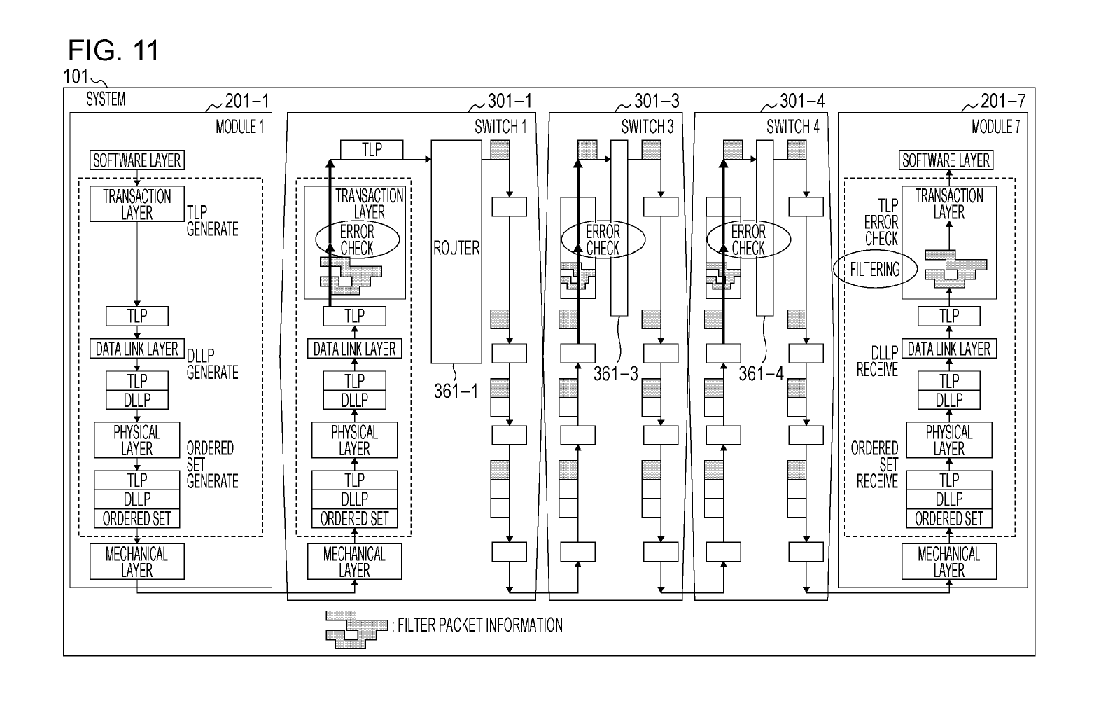

FIG. 12A illustrates a process of the transaction layer of the switch according to the embodiment (when an error is not detected).

In FIG. 12A, a process in the transaction layer of the switch 301-1 in the case where data is not broken is illustrated.

The TL receiver 331-1-1 of the switch 301-1 receives the transaction layer packet 401.

The fixed value region expected value checker 332-1-1 compares the values of fixed value regions of the transaction layer packet 401 with the expected values of the fixed value region expected value information table 404 to check whether the values of fixed value regions match the expected values (expected value check). Note that the locations of the fixed value regions of the transaction layer packet 401 are determined with reference to the variable value region/fixed value region information table 403 of the filter packet information 372-1.

In FIG. 12A, since the data of the transaction layer packet 401 is not broken, the values of fixed value regions of the transaction layer packet 401 match the expected values of the fixed value region expected value information table 404, and it is determined that there is no error.

The fixed value region expected value checker 332-1-1 transfers the transaction layer packet 401 to the router 361-1.

FIG. 12B illustrates a process of the transaction layer of the switch according to the embodiment (when an error is detected).

In FIG. 12B, a process in the transaction layer of the switch 301-1 in the case where data in a fixed value region of a transaction layer packet is broken is illustrated.

The TL receiver 331-1-1 of the switch 301-1 receives the transaction layer packet 401.

Here, it is assumed that the data in a fixed value region of the transaction layer packet 401 is broken in the switch 301-1.

The fixed value region expected value checker 332-1-1 compares the values of fixed value regions of the transaction layer packet 401 with the expected values of the fixed value region expected value information table 404 to check whether the values of the fixed value regions match the expected values (expected value check). Note that the locations of fixed value regions of the transaction layer packet 401 are determined with reference to the variable value region/fixed value region information table 403 of the filter packet information 372-1.

In FIG. 12B, since the data in the fixed value region of the transaction layer packet 401 is broken, the value of the fixed value region of the transaction layer packet 401 does not match the expected value of the fixed value region expected value information table 404, and it is determined that an error is detected.

The fixed value region expected value checker 332-1-1 instructs the error response controller 333-1-1 to make an error response.

In response to the instruction from the fixed value region expected value checker 332-1-1, the error response controller 333-1-1 instructs the error response packet generator 342-1-1 to generate an error response packet.

The error response packet generation part 342-1-1 that has received the instruction generates an error response packet.

The generated error response packet is transmitted to the transmission source module.

Processes of switches in the case where data in a fixed value region of a transaction layer packet is broken will be compared between the related art technology and the embodiment next.

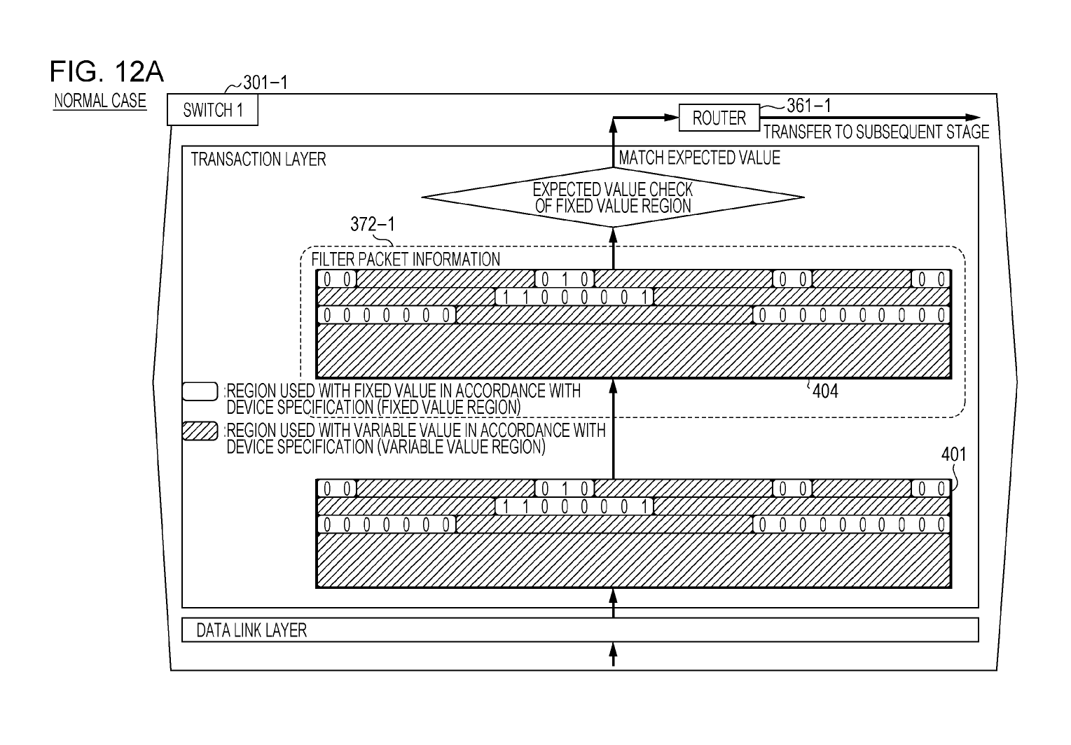

FIG. 13 illustrates packet communication according to the related art technology.

With reference to FIG. 13, a description is given of the case where a packet is transmitted from the module (transmission source module) 1011-1 to the module (transmission destination module) 1011-7.

The module 1011-1 generates a transmission packet P1 including a transaction layer packet and transmits the transmission packet P1 to the module 1011-7 first.

The transmission packet P1 reaches the switch 1031-1.

It is assumed that data in a fixed value region of the transaction layer packet of the transmission packet is broken in the inside of the switch 1031-1.

The transmission packet P1′ whose data is broken is transferred from the switch 1031-1 to the switch 1031-3, and further passes through the switch 1031-4 and reaches the module 1011-7.

In the module 1011-7, an ECRC error check of the transmission packet P1′ whose data is broken is performed, and an error is detected. The module 1011-7 transmits an error response completion packet (CP) to the transmission source module 1011-1.

The error response CP passes through the switches 1031-4, 1031-3, and 1031-1 and reaches the module 1011-1.

Upon receipt of the error response CP, the module 1011-1 transmits a retry packet (RP) to the module 1011-7.

The retry packet passes through the switches 1031-1, 1031-3, and 1031-4 and reaches the module 1011-7.

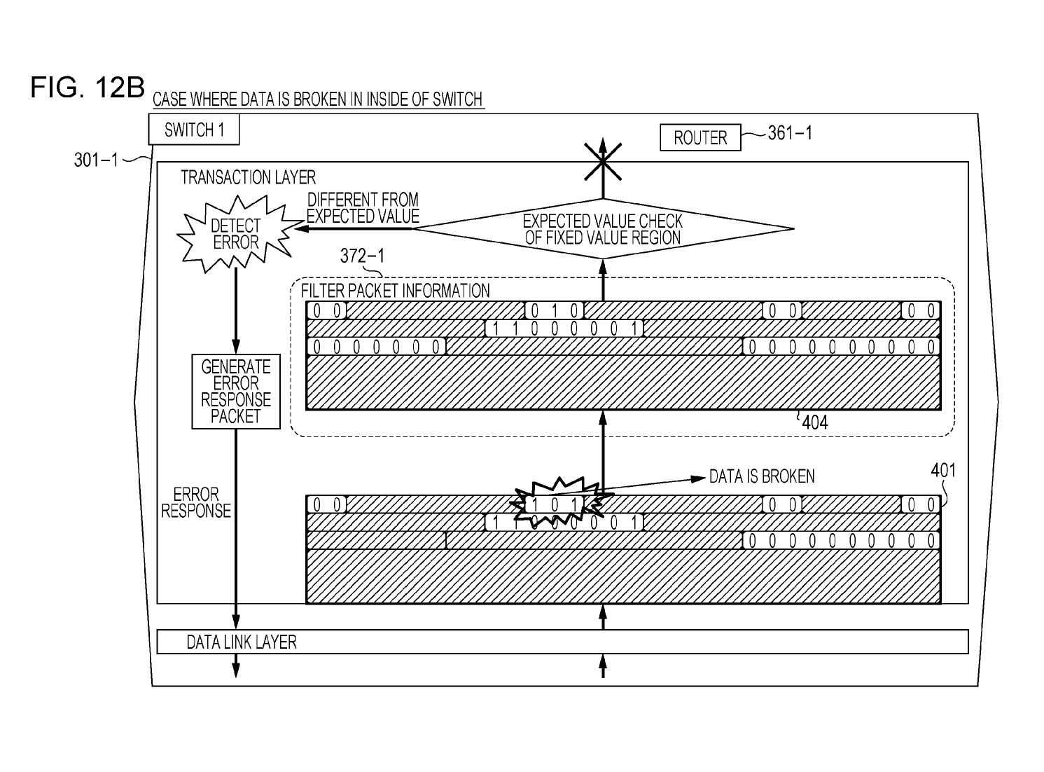

FIG. 14 illustrates packet communication according to the embodiment.

With reference to FIG. 14, a description is given of the case where a packet is transmitted from the module (transmission source module) 201-1 to the module (transmission destination module) 201-7.

Note that, in FIG. 14, the illustrations of the modules 201-4 to 201-6 and 201-10 to 201-12 are omitted.

The module 201-1 generates the transmission packet P1 and transmits the transmission packet P1 to the module 301-7 first.

The transmission packet P1 reaches the switch 301-1.

It is assumed that data in a fixed value region of the transaction layer packet of the transmission packet P1 is broken in the inside of the switch 301-1.

The switch 301-1 performs an expected value check of the fixed value region of the transaction layer packet of the transmission packet P1′ whose data is broken on the basis of filter packet information 302-1.

The switch 301-1 detects an expected value error, and transmits an error response completion packet (CP) to the module 201-1.

Upon receipt of the error response CP, the module 201-1 transmits a retry packet (RP) to the module 201-7.

The retry packet passes through the switches 301-1, 301-3, and 301-4, and reaches the module 201-7.

In the related art packet communication illustrated in FIG. 13, the packet P1′ that is broken in the inside of the switch 1031-1 is transferred from the switch 1031-1 to the transmission destination module 1011-7 at the later stage. Then, an ECRC error is detected for the first time in the module 1011-7, and an error response is returned from the module 1011-7 to the module 1011-1. Then, the module 1011-1 receives the error response and retransmits a packet.

In contrast to this, in the packet communication of the embodiment illustrated in FIG. 14, the switch 301-1 performs an expected value check of fixed value regions using the filter packet information 302-1 to detect an error, and returns an error response to the module 201-1. The module 201-1 receives the error response and retransmits a packet.

As such, in the packet communication of the embodiment, the packet P1′ that is broken in the inside of the switch 301-1 is not transferred to the switches 301-3 and 301-4 and module 201-7 at the later stage. This may inhibit a decrease in the transfer rate of the network bandwidth at the later stage.

Operations of a switch for manners in which data is broken will be compared between the related art technology and the embodiment next.

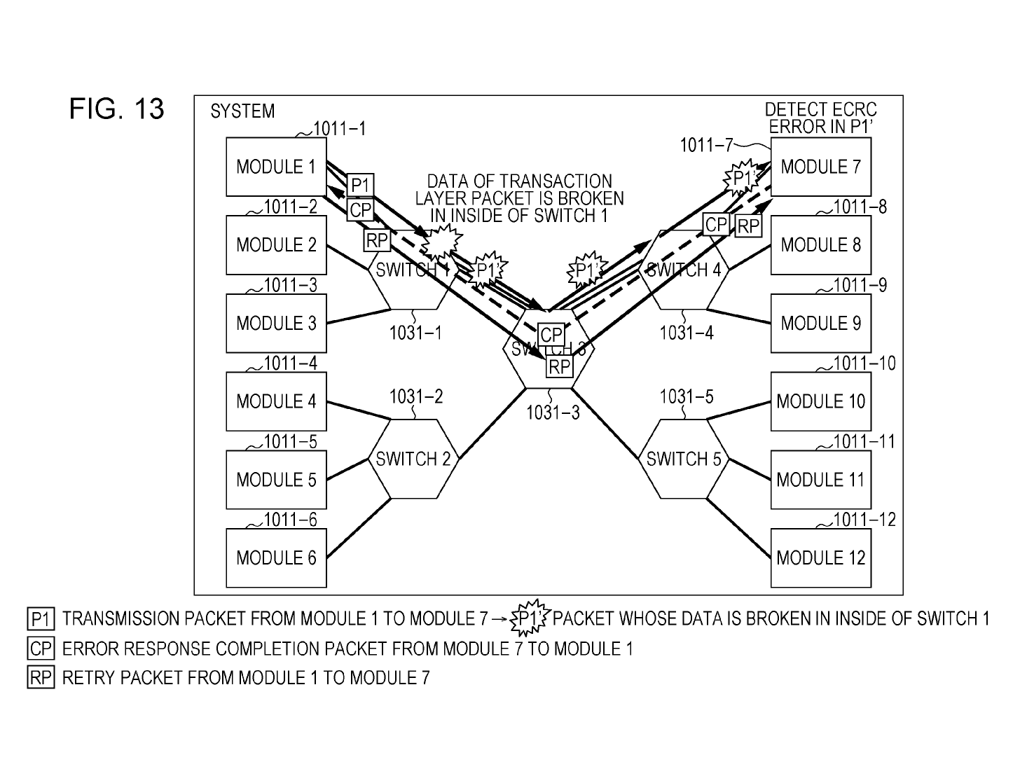

FIG. 15 illustrates states of a transaction layer packet according to the related art technology and operations of a switch.

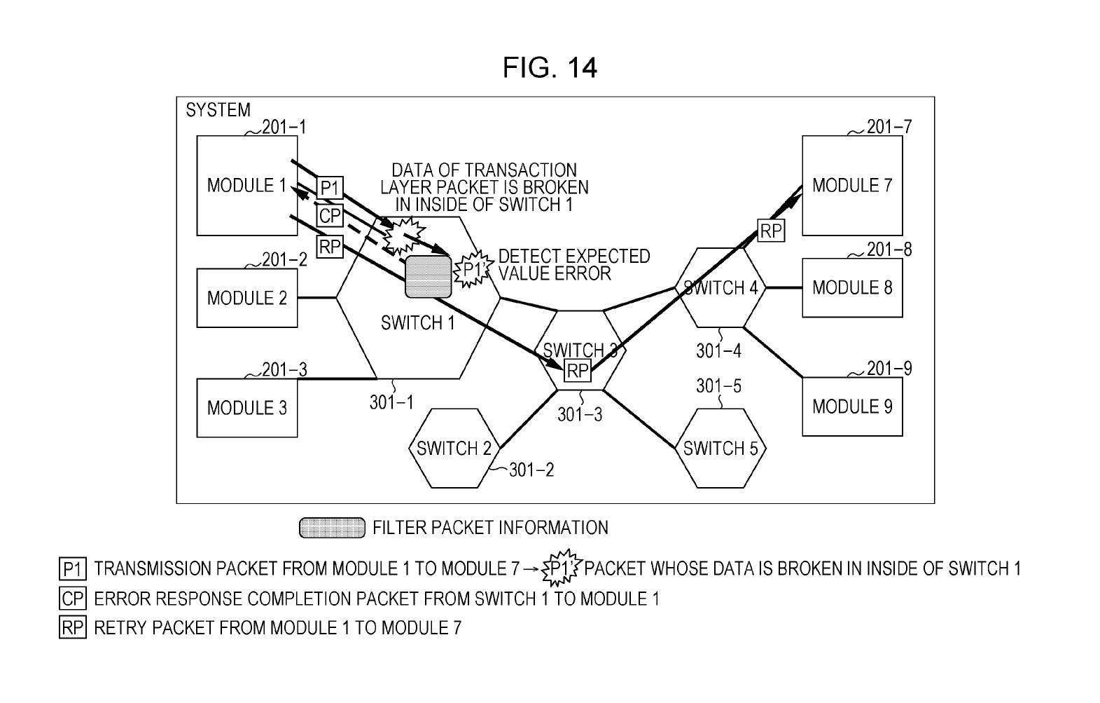

FIG. 16 illustrates states of a transaction layer packet according to the embodiment and operations of a switch.

FIGS. 15 and 16 each illustrate operations of a switch for the cases where the variable value region and the fixed value region of a transaction layer packet received by the switch are each normal or an error (abnormal).

Note that FIG. 15 illustrates operations of the switch 1031-1 that has received a transmission packet from the module (transmission source module) 1011-1 to the module (transmission destination module) 1011-7, and FIG. 16 illustrates operations of the switch 301-1 that has received a transmission packet from the module (transmission source module) 201-1 to the module (transmission destination module) 201-7.

With reference to FIGS. 15 and 16, there is no difference in operations between the related art technology and the embodiment for Case 1 (the variable value region is normal, and the fixed value region is normal) and Case 3 (the variable value region is abnormal, and the fixed value region is normal). That is, a transmission packet is transferred to the transmission destination module in both of the related art technology and the embodiment.

In Case 2 (the variable value region is normal, and the fixed value region is abnormal) and Case 4 (the variable value region is abnormal, and the fixed value region is abnormal), an error check of a transaction layer packet in the switch 1031-1 is not performed in the related art technology. As a result, the transaction layer packet is transferred from the switch 1031-1 to the switch 1031-3 and further passes through the switch 1031-4 and reaches the module 1011-7.

In contrast to this, in Case 2 (the variable value region is normal, and the fixed value region is abnormal) and Case 4 (the variable value region is abnormal, and the fixed value region is abnormal), the switch 301-1 performs an error check of the fixed value region of the transaction layer packet in the embodiment. Therefore, in Case 2 and in Case 4, an error is detected in the switch 301-1, and an error response is returned to the module 201-1 as the transmission source. That is, the transmission packet is not transferred to the switch 301-3, 301-4, and module 201-7 at the later stage.

In Case 2 (the variable value region is normal, and the fixed value region is abnormal) and in Case 4 (the variable value region is abnormal, and the fixed value region is abnormal), as described above, in the embodiment, a transmission packet is not transferred to devices after the switch where an error of the fixed value region is detected. This may inhibit a decrease in the transfer rate of the network bandwidth at the later stage.

Processes of modules in the case where data in the fixed value region of a transaction layer packet is broken will be compared between the related art technology and the embodiment next.

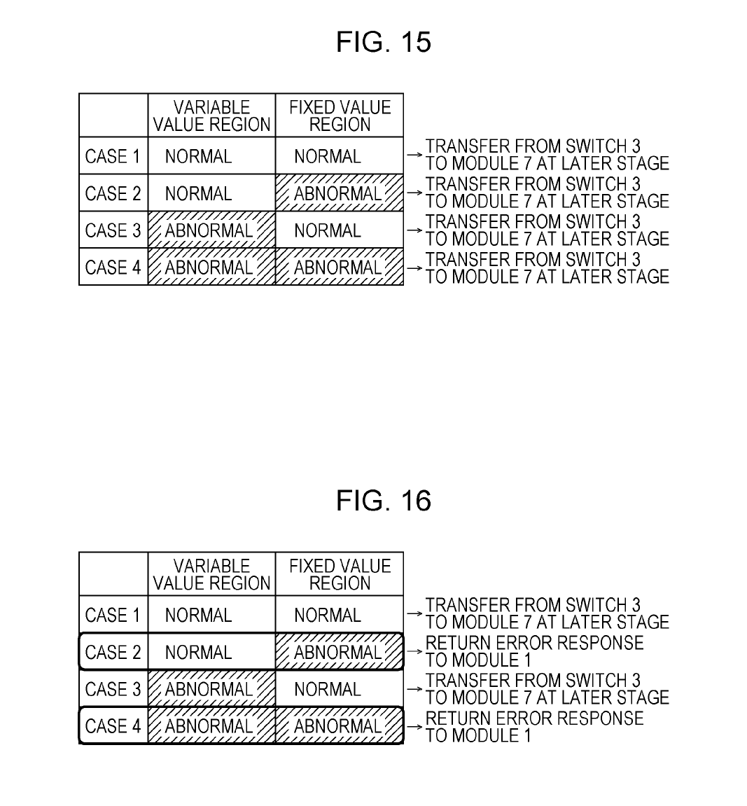

FIG. 17 illustrates an error check process of the modules according to the embodiment.

With reference to FIG. 17, a description is given of the case where a packet is transmitted from the module (transmission source module) 201-1 to the module (transmission destination module) 201-7.

The module 201-1 generates the transmission layer packet 401 and transmits the transmission layer packet 401 to the module 201-7 first.

It is assumed that data in a fixed value region of the transaction layer packet 401 is broken halfway along the transmission path. It is also assumed that data of the variable value regions is not broken. Note that it is assumed that an expected value check is not performed in the switches 301-1, 301-3, and 301-4.

A transaction layer packet 401′ whose data in the fixed value region is broken reaches the module 201-7.

Using the fixed value region expected value information table 404 of the filter packet information 202-7, the module 201-7 overwrites the fixed value regions of the transaction layer packet 401′ with expected values of the fixed value region expected value information table 404.

As a result, the transaction layer packet 401′ whose data in the fixed value region is broken becomes the normal transaction layer packet 401.

In the module 201-7, an ECRC error check is performed for the transaction layer packet 401 whose fixed value regions are overwritten with the expected values. An error is not detected, and it is determined that the packet is normally received.

The module 201-7 transmits a completion packet (normal response packet) to the module 201-1.

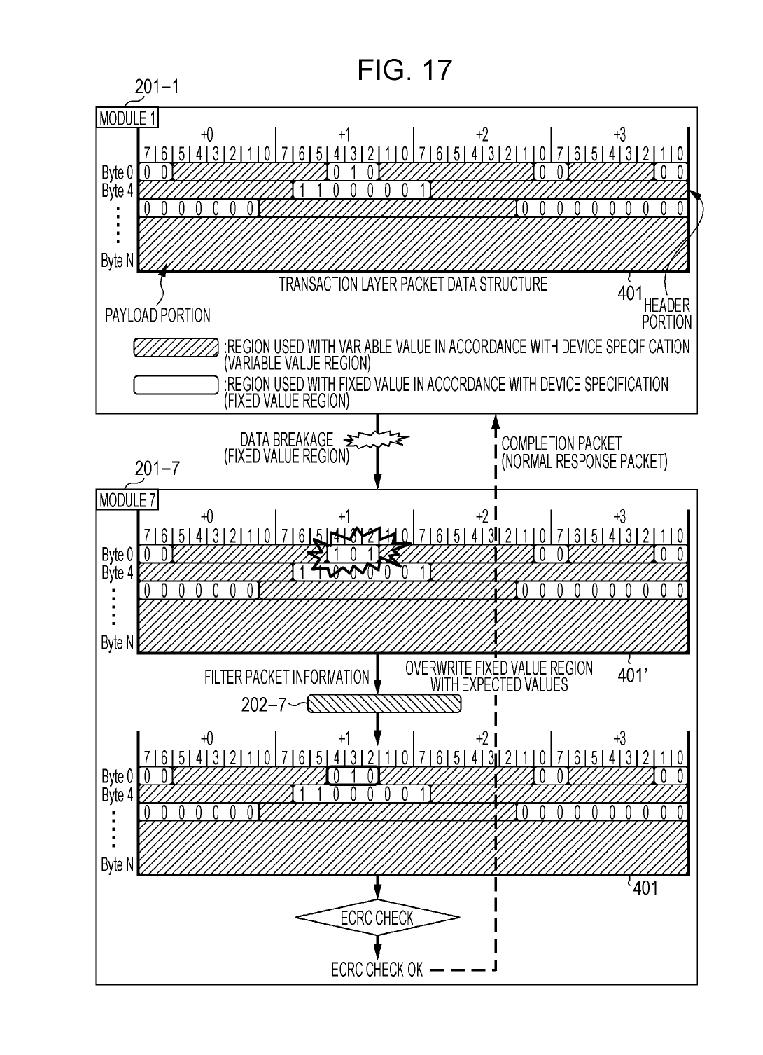

FIG. 18 illustrates an error check process of the modules according to the related art technology.

With reference to FIG. 18, a description is given of the case where a packet is transmitted from the module (transmission source module) 1101-1 to the module (transmission destination module) 1011-7.

The module 1011-1 generates the transmission layer packet 401 and transmits the transmission layer packet 401 to the module 1011-7 first.

It is assumed that data in a fixed value region of the transaction layer packet 401 is broken halfway along the transmission path. It is also assumed that data of the variable value regions is not broken.

The transaction layer packet 401′ whose data in the fixed value region is broken reaches the module 1011-7.

In the module 1011-7, an ECRC error check is performed for the transaction layer packet 401′ whose data in the fixed value region is broken, and an error is detected.

The module 1011-7 makes an error response to the module 1011-1, and the module 1011-1 retransmits a packet (retry packet).

As described above, even when only data in a region (fixed value region) to be used with fixed values in accordance with device specifications is broken, the related art transmission destination module performs an ECRC error check for all the regions of the packet in the transaction layer, and therefore the packet is handled as an error. The transmission source module receives the error response and carries out retransmission. This imposes a load on the network by an amount corresponding to the retransmission.

In contrast to this, with the embodiment of FIG. 17, the transmission destination module modifies the fixed value region by forcibly overwriting the fixed value region with the expected value defined by the filter packet information, and performs an ECRC error check of the entire transaction layer. Therefore, even when only data in a region to be used with fixed values in accordance with the device specifications is broken, the packet is consequentially handled as a normal packet. As a result, retransmission of the transmission source module does not have to be carried out. Thus, the load on the network is reduced by an amount corresponding to the retransmission.

Operations of a switch for manners in which data is broken will be compared between the related art technology and the embodiment next.

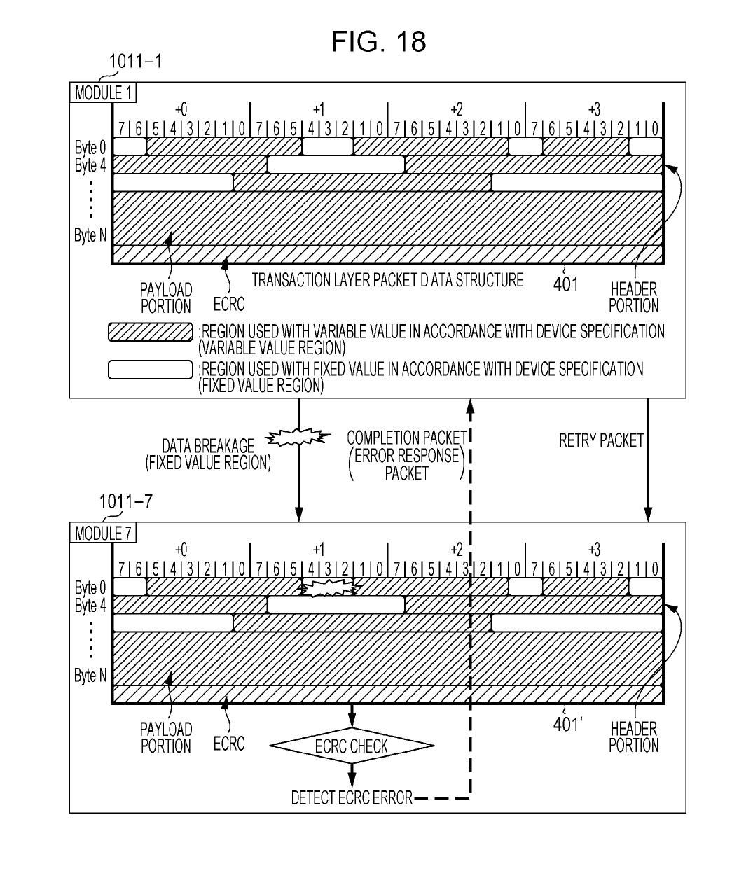

FIG. 19 illustrates states of a transaction layer packet according to the related art technology and the results of operations of a module.

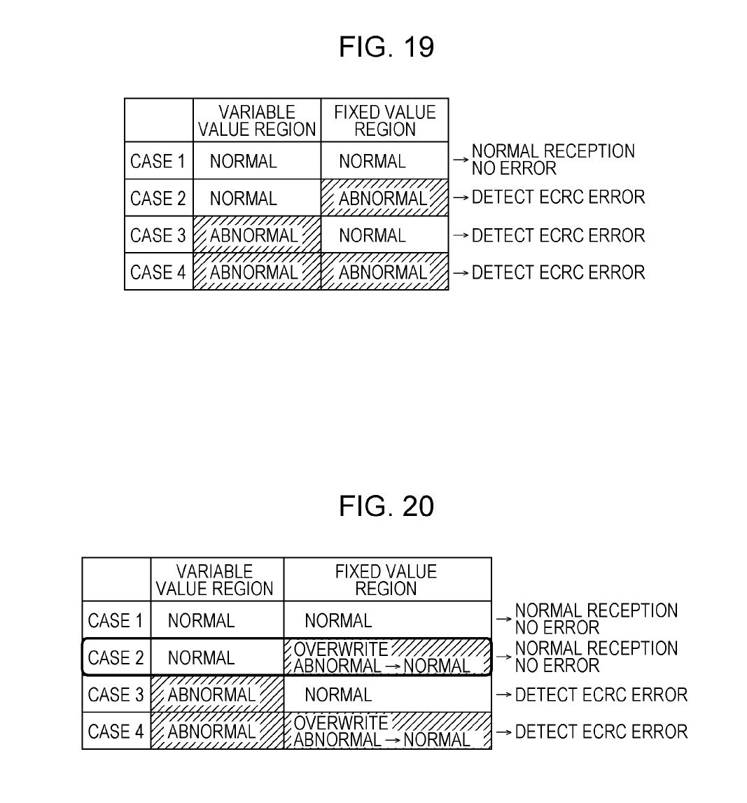

FIG. 20 illustrates states of a transaction layer packet according to the embodiment and the results of operations of the module.

FIGS. 19 and 20 each illustrate the results of operations of a module for the cases where the variable value region and the fixed value region of a transaction layer packet received by the module are each normal or an error (abnormal).

With reference to FIGS. 19 and 20, there is no difference in the results of operations between the related art technology and the embodiment for Case 1 (the variable value region is normal, and the fixed value region is normal), Case 3 (the variable value region is abnormal, and the fixed value region is normal), and Case 4 (the variable value region is abnormal, and the fixed value region is abnormal).

Regarding Case 2 (the variable value region is normal, and the fixed value region is abnormal), an ECRC error is detected in the module and a packet is retransmitted in the related art technology. In contrast to this, regarding Case 2 (the variable value region is normal, and the fixed value region is abnormal), in the embodiment, the fixed value region of the transaction layer received by the module is overwritten with the expected values, and therefore the values in the fixed value region become normal values. Accordingly, an ECRC error is not detected and reception of a normal packet is performed.

As described above, regarding Case 2 (the variable value region is normal, and the fixed value region is abnormal), a packet is retransmitted in the related art technology whereas a packet is not retransmitted in the embodiment and thus a decrease in the transfer rate is inhibited.

With the switch of the embodiment, an expected value check of a fixed value region of a received transaction layer packet is performed. If an error is detected, the switch makes an error response to the transmission source module because there is a possibility that data in a variable value region is also broken. In this way, the switch of the embodiment does not transfer the packet in which the error has been detected to a device located at the later stage. Therefore, the transfer rate between the switch in which the error is detected and the transmission destination module may be inhibited from decreasing.

With the module of the embodiment, even when data in a fixed value region of the received transaction layer packet is broken, the fixed value region is overwritten, and therefore an error is not detected and a packet is not retransmitted. Thus, a decrease in the transfer rate may be inhibited.

The present disclosure is not intended to be limited to the foregoing embodiment and may be made in various configurations without departing from the scope of the present disclosure.

In the system of the embodiment, the configuration of the system may be not a configuration in which the module and switch of the embodiment are simultaneously used. For example, in the system of the embodiment, the configuration may be such that the module of the embodiment is used as the module and the switch of the related art technology is used as the switch. Also, in the system of the embodiment, the configuration may be such that the module of the related art technology is used as the module and the switch of the embodiment is used as the switch.

Also, in the system of the embodiment, the configuration may be such that the transmission source module and the transmission destination module are directly connected without via a switch.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A system comprising:
a transmitting device configured to transmit a packet; and
a receiving device connected through a switch device to the transmitting device, the receiving device being configured to receive the packet,
wherein the switch device includes
a first memory storing first expected value information indicative of an expected value of a fixed value region, the fixed value region being a region whose value is determined in advance in a transaction layer packet, and
a switch control unit configured to compare a value of the fixed value region of the transaction layer packet received from the transmitting device with the expected value and make an error response to the transmitting device if the value of the fixed value region is different from the expected value.

2. The system according to claim 1,
wherein the receiving device includes
a second memory storing second expected value information indicative of the expected value of the fixed value region,
an overwriting unit configured to overwrite the value of the fixed value region of the transaction layer packet received from the switch with the expected value, and
an error checking unit configured to perform an error check of the transaction layer packet overwritten with the expected value.

3. The system according to claim 1,
wherein the first memory further stores first fixed value region information indicative of a location of the fixed value region, and
wherein the switch control unit determines the location of the fixed value region of the transaction layer packet on the basis of the first fixed value region information.

4. The system according to claim 2,
wherein the second memory further stores second fixed value region information indicative of a location of the fixed value region, and
wherein the overwriting unit determines the location of the fixed value region of the transaction layer packet on the basis of the second fixed value region information.

5. A communication method performed by a system including a transmitting device configured to transmit a packet, and a receiving device connected through a switch device to the transmitting device, the receiving device being configured to receive the packet, the communication method comprising:
in the switch device including a first memory storing first expected value information indicative of an expected value of a fixed value region, the fixed value region being a region whose value is determined in advance in a transaction layer packet,
comparing a value of the fixed value region of the transaction layer packet received from the transmitting device with the expected value; and
making an error response to the transmitting device if the value of the fixed value region is different from the expected value.

6. The communication method according to claim 5, wherein
in the receiving device including a second memory storing second expected value information indicative of the expected value of the fixed value region,
the value of the fixed value region of the transaction layer packet received from the switch is overwritten with the expected value, and
an error check of the transaction layer packet overwritten with the expected value is performed.

7. The communication method according to claim 5,
wherein the first memory further stores first fixed value region information indicative of a location of the fixed value region, and
wherein, in the switch device, the location of the fixed value region of the transaction layer packet is determined on the basis of the first fixed value region information.

8. The communication method according to claim 6,
wherein the second memory further stores second fixed value region information indicative of a location of the fixed value region, and
wherein, in the receiving unit, the location of the fixed value region of the transaction layer packet is determined on the basis of the second fixed value region information.
